(19) United States
(12) Patent Application Publication
(10) Pub. No.: US 2005/0000252 A1
(43) Pub. Date: Jan. 6, 2005

(54) Method and apparatus for fabricating optical fiber preform using double torch in mcvd

(76) Inventors: Chan-Joo Lee, Seoul (KR); Soo-Il Son, Gyeonggi-do (KR); Ji-Sang Park, Gyeonggi-do (KR)

Correspondence Address: JONES DAY, 222 EAST 41ST ST, NEW YORK, NY, 10017, US

(21) Appl. No.: 10/497,093

(22) PCT Filed: Feb. 26, 2003
(86) PCT No.: PCT/KR03/00387

(30) Foreign Application Priority Data
Sep. 18, 2002 (KR) 10-2002-0056903

(51) Int. Cl. C03B 37/018

(52) U.S. Cl. 65/417; 65/426; 65/530; 65/494

(57) ABSTRACT

Disclosed is a method for fabricating an optical fiber preform using a double torch in MCVD, which includes a first process of heating a quartz tube (10) at a temperature lower than a sintering temperature by using a first torch (21) with putting reaction gas, oxygen gas and dehydration gas into the tube so that soot particles are generated and deposited, and heating the tube to a predetermined temperature by using a second torch (22) spaced apart from the first torch after the first torch (21) passes so that moisture in the soot particles is removed; and a second process of conducting dehydration for removing moisture in the soot particles by use of the first torch (21) again, and heating the tube above a sintering temperature by using the second torch (22) so that the soot particles free from moisture are vitrified.

### TECHNICAL HELD

The present invention relates to method and apparatus for fabricating an optical fiber preform in MCVD (Modified Chemical Vapor Deposition), and more particularly to method and apparatus for fabricating an optical fiber preform in MCVD, which includes a dehydration process for removing moisture by injection of dehydration gas after the vapor deposition process of core or clad and before the sintering process and improves productivity by using two torches at the same time.

### BACKGROUND ART

Currently, many methods such as MCVD (Modified Chemical Vapor Deposition), OVD (Outside Vapor Deposition), VAD (Vapor phase Axis Deposition), and PCVD (Plasma Chemical Vapor Deposition) are used to make an optical fiber preform. Among them, MCVD is widely used since it is conducted in an airtight space, thus showing less inflow of impurities.

FIG. 1 is showing the MCVD in brief. Referring to FIG. 1, with rotating a quartz tube 1, reaction gas such as SiCl₄, GeCl₄ and POCl₃ are blown into the quartz tube 1 together with oxygen gas. At this time, a torch 2 positioned out of the tube reciprocates and heats the tube at a temperature above 1600° C. so that the reaction gas flowed into the tube is sufficiently reacted. Whenever the torch reciprocates once, soot 3 is generated at a heated portion due to oxidization reaction. This soot particles move in a direction that the torch advances, that is toward a portion which is not yet heated, and then adhered to an inner surface of the tube by means of thermophoresis. The soot SiO₂ and GeO₂ adhered to the inner surface of the tube is sintered by the following heat of the torch, thereby making a glass layer 4. This process is continuously repeated to make a clad layer and a core layer having higher index of refraction than the clad layer in the tube.

Since MCVD is processed at a high temperature above 1600° C., the generated soot is sintered just after being deposited. As a result, in the quartz tube 1, OH³¹ ions and moisture as a reaction residual are physically or chemically combined to the inside of the soot 3 or the glass layer 4.

FIG. 2 shows that hydroxyl groups and moisture are attached to the soot particle. The moisture molecules are physically adsorbed to the particle surface, and OH³¹ ions are chemically combined in SiO₂, then both of them cause optical losses later.

In order to remove OH³¹ ions and moisture, an applicant of this invention has ever filed a patent application related to the method for removing moisture in an optical fiber by applying the dehydration process, which is well shown in FIGS. 3 to 5. FIG. 3 shows a sooting step in which the reaction gas and the oxygen gas are put into the tube 5, the torch 6 applies heat out of the tube 5 to generate soot particles 7, and the generated soot particles are deposited to the inner of the tube by means of thermophoresis when passing the torch. FIG. 4 shows a dehydration step of removing moisture existing in the soot particles 7 deposited to the inner wall of the tube by applying heat with the torch 6 with putting dehydration gas into the tube 5. FIG. 5 shows a sintering step of forming the glass layer 8 by heating a deposition surface free from moisture in the tube 5 at a temperature above a sintering temperature by the torch 6.

This technique classifies the MCVD, which is conventionally composed of the sooting and sintering steps, into the sooting, dehydration and sintering steps, and among the steps, hydroxyl ions and moisture are removed by means of the dehydration step. This technique is advantageous in view of making an optical fiber having better quality than the conventional one. However, the technique has a disadvantage in that it needs longer procedure time since the procedure is subdivided into more steps, compared with the conventional MCVD which progresses the sooting step and the sintering step in bundle. In other words, though the conventional MCVD requires one reciprocation of the torch for piling up one deposition layer, the technique requires three reciprocations of the torch since each of the sooting, dehydration and sintering steps needs different temperature, thereby giving 1/3 productivity.

In addition, compared with other methods, OVD or VAD passes the dehydration step, the vitrification step and the sintering step while a porous preform in soot state is in a sintering furnace. In other words, in OVD or VAD, a preform is slowly heated from a low temperature to or above 150° C. in order to remove moisture physically adsorbed to the particle surface, and then residual moisture remaining above the temperature is chemically removed using dehydrogenation reactant. On the other hand, since the above technique conducts the dehydration partially only at a position where the torch moves, pollution problems such as rehydration after dehydration or defect site may arise.

### DISCLOSURE OF INVENTION

The present invention is designed to solve problems of the prior art, therefore an object of the invention is to provide method and apparatus for fabricating an optical fiber preform using double torch in MCVD, which may reduce reciprocating frequency and time of the torch by installing two torches so both sooting and dehydration or both dehydration and sintering are progressed at once, and dramatically lower optical losses by completely removing moisture remained after the first dehydration step since the dehydration step is repeated.

In order to accomplish the above object, the present invention provides a method for fabricating an optical fiber preform in MCVD (Modified Chemical Vapor Deposition), which includes a first process of heating a quartz tube at a temperature lower than a sintering temperature by using a first torch with putting reaction gas, oxygen gas and dehydration gas into the tube so that soot particles are generated and deposited, and heating the tube to a predetermined temperature by using a second torch spaced apart from the first torch after passing the first torch so that moisture in the soot particles is removed; and a second process of conducting dehydration for removing moisture in the soot particles by use of the first torch again, and heating the tube above a sintering temperature by using the second torch so that the soot particles free from moisture are vitrified.

Preferably, the first and second torches supplies heat to the quartz tube below 1700° C. when generating and depositing soot particles, below 1200° C. when removing moisture, and above 1700° C. when vitrifying the soot particles.

Also preferably, the first and second torches are spaced apart from each other as much as 100 mm or more, and move at different speeds below 500 mm/min.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a schematic view for illustrating a method for fabricating an optical fiber preform according to the conventional MCVD;

FIG. 2 shows a soot generated according to the MCVD of FIG. 1, to which moisture is adsorbed;

FIG. 3 is a schematic view showing a sooting step of the conventional MCVD;

FIG. 4 is a schematic view showing a dehydration step of the conventional MCVD;

FIG. 5 is a schematic view showing a sooting step of the conventional MCVD;

FIG. 6 is a schematic view showing a sooting and dehydration process according to the present invention; and

FIG. 7 is a schematic view showing a dehydration and sintering process according to the present invention.

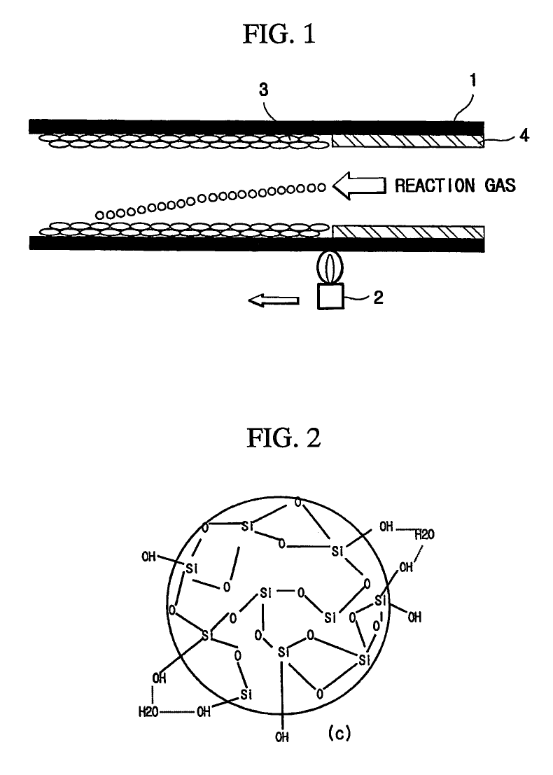

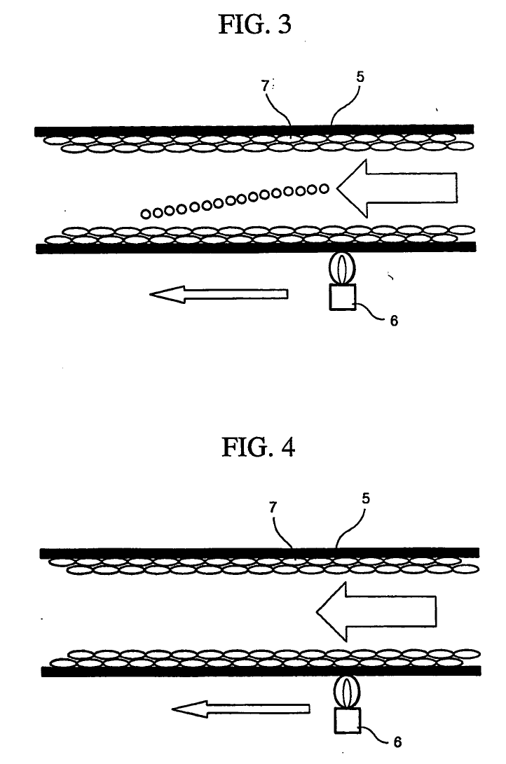

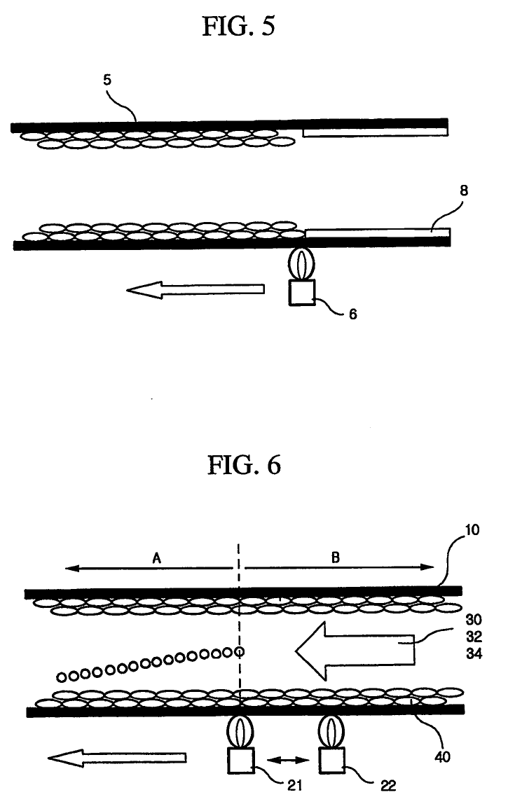

### BEST MODES FOR CARRYING OUT THE INVENTION

Hereinafter, preferred embodiments of the present invention will be described in detail with reference to the accompanying drawings.

At first, FIG. 6 shows a sooting (A) and dehydration (B) process according to the present invention. A quartz tube 10 rotates with being put on a lathe (not shown). Reaction gas, oxygen gas and hydrogen gas are flowed into the quartz tube 10 from a gas supply unit (not shown). Torches are installed out of the quartz tube 10 as a heat source for reaction. The torches reciprocate in a longitudinal direction of the quartz tube according to the procedure.

To describe in more detail, there are installed two torches for supplying heat to the quartz tube 10. The first torch 21 conducts sooting (A), and the second torch 22 installed spaced apart from the first torch 22 as much ash a predetermined distance conducts dehydration (B). At this time, the torches 21 and 22 may be operated at the same time by one moving means such as a carriage (not shown), or may also be moved at different speeds by different moving means such as a carriage.

In the sooting (A), the first torch 21 applies heat to the quartz tube 10 so that the reaction gas 30 such as SiCl₄, GeCl₄, POCl₃ blown into the quartz tube 10 is oxidized with the oxygen gas 32 to generate soot particles 40. At this time, the temperature supplied to the tube is preferably below about 1700° C., and more preferably kept in the range of 1400˜1700° C. so that the gas may have sufficient reaction energy. The reason of keeping the temperature as described above is that, if heating the tube at a temperature above 1700° C. which is a sintering temperature of silica particles, the soot particles 40 deposited on the inside of the quartz tube are sintered with possessing moisture and OH³¹ groups. Furthermore, a moving speed of the first torch 21 at this time is preferably kept below 500 mm/min so that the reaction gas and the oxygen gas may be sufficiently reacted.

The second torch 22 installed spaced apart from the first torch 21 as much as a predetermined distance supplies heat for dehydration (B) to the tube in order to remove moisture existing in the deposited soot particles 40 after completing the sooting. At this time, the temperature of the tube is preferably kept below 1200° C., more preferably kept in the range of 600˜1200° C. in order to prevent the deposited soot particles from being sintered even partially. During the dehydration, dehydration gas such as He, Cl₂ and O₂ is put into the quartz tube 10 so as to induce dehydration reaction. Among the media for removing moisture, chlorine gas is known as the most effective dehydrating agent, and reacted as follows.

Reaction Formula 1
4Si—OH+2Cl₂ [symbol] 2SiOSi+4HCl+O₂
Si—OH—Cl₂ [symbol] Si—O—Si+HCl
2H₂O+Cl₂ [symbol] 2HCl+O₂

Most OH³¹ groups may be removed below 1200° C. Over 1200° C., particles in soot state are decreased, and it becomes rather a temperature where the vitrification is possible, so the concentration of OH³¹ groups is increased. In more detail, at a temperature above 1200° C., the particles are decreased, a diameter of the particles is increased and pores are disappeared. As a result, a growth rate of particles becomes faster than a dispersion rate of OH³¹ groups existing in the particles since the pores are disappeared, so OK groups cannot escape from the deposited soot particles but are captured therein. Thus, it is preferred at this time that the second torch 22 keeps a moving speed at 500 mm/min so that the hydroxyl groups may be sufficiently reacted with the dehydration gas, and it is also preferred that the concentration of hydrogen ion is less than 1 ppb in the preform by weight.

According to the present invention, a distance between the first torch 21 and the second torch 22 is preferably kept as much as 100 mm or more. The temperature of the first torch 21 is lower than 1700° C. in the sooting (A) and the temperature of the second torch 22 is lower than 1200° C. in the dehydration (B). Thus, if the distance between the first and second torches 21 and 22 is not kept sufficiently, a deposition surface of the soot particles 40 may become uneven due to abrupt temperature difference.

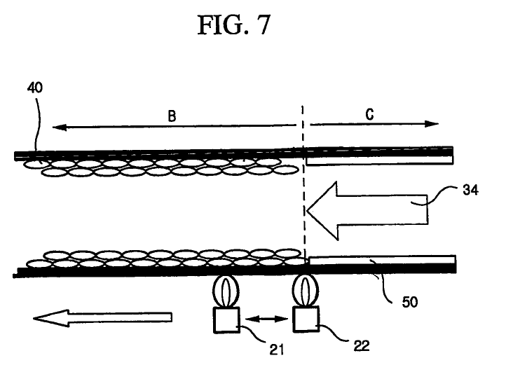

FIG. 7 shows a dehydration (B) and sintering (C) process according to the present invention. Referring to FIG. 7, after the sooting (A) and dehydration (B) process, the torches 21 and 22 return to their initial positions. After returning, the first torch 21 again supplies heat for the dehydration (B), and the second torch 22 supplies heat for the sintering (C). Preferably, in this process, the first torch 21 keeps a temperature lower than 1200° C., and the second torch 22 keeps a temperature higher than 1700° C.

Here, the dehydration in this process is conducted in the same way as the dehydration in the sooting (A) and dehydration (B) process, thereby completely eliminating residual moisture, which is not sufficiently removed in the sooting and dehydration process. Detailed description of the dehydration in this process refers to the above explanation of the sooting and dehydration process.

During the sintering (C), the second torch 22 supplies heat over 1700° C. to the preform with being spaced apart from the first torch 21 conducting the dehydration (B) as much as a predetermined distance, preferably more than 100 mm. 1700° C. is a vitrification temperature of silica particles, so if the quartz tube 10 is heated over this temperature, the soot particles deposited to the inner wall of the tube form a glass layer 50. At this time, the second torch 22 is preferably moved at a speed less than 500 mm/min so that the vitrification is progressed regularly not to generate distortion on the deposition surface. In addition, even during executing the sintering (C), it is preferred that dehydration gas 34 such as He, Cl₂ and O₂ is continuously put into the quartz tube 10 so as to remove residual moisture, which is not reacted and remains in the quartz tube 10 and the soot particles 40.

If conducting the sooting and dehydration process and the dehydration and sintering process, one clad layer is formed, and these processes are continuously repeated until the clad layer has a desired thickness.

In addition, if the clad layer reaches a predetermined thickness, ratios of the reaction gas and the oxygen gas are set differently and the above processes are continuously repeated to obtain a core layer having a desired thickness.

If the core layer having a desired thickness is obtained, the reaction gas is not put into the tube any more, and the collapsing process for supplying heat by use of a torch out of the tube with putting suitable gas therein is executed so that an inner space of the clad and core layers is shrunk and in the end disappeared. Then, a preform having no inner space is perfected.

### INDUSTRIAL APPLICABILITY

According to the method and apparatus for fabricating an optical fiber preform using double torch in MCVD of the present invention, since two torches are installed so that both sooting and dehydration and both dehydration and sintering are conducted at the same time, reciprocating frequency and time of the torch are reduced and so the productivity may be improved, compared with the conventional method conducting three steps such as sooting, dehydration and sintering. In addition, since the dehydration is conducted twice, moisture remaining after the first dehydration may be eliminated completely. Thus, an optical loss generated by OH³¹ groups at a frequency of 1385 nm is remarkably reduced, so it becomes possible to make an optical fiber which may be used in a broader wavelength range.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

1. A method for fabricating an optical fiber preform in MCVD (Modified Chemical Vapor Deposition) comprising:
a first process of heating a quartz tube (10) at a temperature lower than a sintering temperature by using a first torch (21) with putting reaction gas, oxygen gas and dehydration gas into the tube so that soot particles are generated and deposited, and heating the tube to a predetermined temperature by using a second torch (22) spaced apart from the first torch after passing the first torch (21) so that moisture in the soot particles is removed; and
a second process of conducting dehydration for removing moisture in the soot particles by use of the first torch (21) again, and heating the tube above a sintering temperature by using the second torch (22) so that the soot particles free from moisture are vitrified.

2. A method for fabricating an optical fiber preform in MCVD according to claim 1,
wherein the temperature for generation and deposition of the soot particles is below 1700° C., the temperature for removal of the moisture is below 1200° C., and the sintering temperature for vitrification is above 1700° C.

3. A method for fabricating an optical fiber preform in MCVD according to claim 1 or 2,
wherein the first torch (21) and the second torch (22) are spaced apart from each other as much as 100 mm or more.

4. A method for fabricating an optical fiber preform in MCVD according to claim 3,
wherein the first and second torches (21)(22) move at different speeds below 500 mm/min.

5. An apparatus for fabricating an optical fiber preform in MCVD for depositing and sintering soot particles in a quartz tube, comprising:
a gas supply unit for supplying reaction gas, oxygen gas and dehydration gas into the quartz tube;
a first torch positioned at a relatively front portion of an advancing direction so as to heat a surface of the quartz tube; and
a second torch spaced apart from the first torch as much as a predetermined distance and positioned at a relatively rear portion of the advancing direction along the quartz tube,
wherein the first and second torches give heat at different set temperatures,
whereby the first and second torches heat the quartz tube so that both deposition reaction and dehydration reaction or both dehydration reaction and sintering reaction are accomplished at once.

6. An apparatus for fabricating an optical fiber preform in MCVD according to claim 5, further comprising means for moving the first and second torches at the same speed.

7. An apparatus for fabricating an optical fiber preform in MCVD according to claim 5, further comprising means for moving the first and second torches at different speeds.

8. An apparatus for fabricating an optical fiber preform in MCVD according to claim 6 or 7,
wherein the first and second torches move at a speed less than 500 mm/min.

9. An apparatus for fabricating an optical fiber preform in MCVD according to claim 5,
wherein the first and second torches are spaced apart from each other as much as 100 mm or more.
